(19) United States
(12) Patent Application Publication
(10) Pub. No.: US 2005/0129029 A1
(43) Pub. Date: Jun. 16, 2005

(54) Using a mobile control channel to roam between networks

(75) Inventors: Thomas E. Creamer, Boca Raton, FL (US); Neil A. Katz, Parkland, FL (US); Victor S. Moore, Boynton Beach, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/736,137

(22) Filed: Dec. 15, 2003

(51) Int. Cl. H04L 12/28

(52) U.S. Cl. 370/395.52

(57) ABSTRACT

A method of roaming between mobile and wireless networks can include detecting a wireless network and querying the wireless network for an Internet Protocol address for a mobile device. The Internet Protocol address can be received. Accordingly, a message can be sent to a mobile switching center of the mobile network using a mobile network control channel. The message can instruct the mobile switching center to route voice data intended for the mobile device to the Internet Protocol address via a communicatively linked gateway and the wireless network.

### BACKGROUND

1. Field of the Invention

The invention relates to the field of mobile communications and, more particularly, to the use of wireless networking in conjunction with mobile networks.

2. Description of the Related Art

Wireless networks are becoming increasingly prevalent with thousands of so called hotspots being deployed throughout the United States, Europe, and Asia. A hotspot refers to the coverage area surrounding a wireless access point within which a device can communicate wirelessly with the access point. The access point typically includes a wireless transceiver and is connected to a packet-switched communications network such as the Internet. As such, the access point provides network connectivity to those devices capable of establishing a wireless communications link with the access point. Examples of hotspots or wireless networks can include those networks built around one of the 802 wireless communications protocols such as 802.11, 802.16, 802.20, and 802.15.

While users may be able to roam between a limited number of hot spots while maintaining connectivity with a communications network, most wireless networks are not yet connected together. More often than not, users are unable to seamlessly roam from one 802.xx network to another. Such wireless networks largely function as data networks and are maintained independently of mobile communications networks. In the usual case, voice communications are not carried over such networks. In consequence, the voice capability of mobile networks has yet to be integrated with wireless networks. Equally limiting is the lack of common billing and administration, particularly registration, authentication, and the like.

What is needed is a way to provide users with a common experience, support, and billing when roaming.

### SUMMARY OF THE INVENTION

The present invention provides a method, system, and apparatus for allowing a mobile communications device user to roam between a mobile network and a wireless network. In particular, the present invention allows a mobile communications device to utilize a mobile network control channel to inform a mobile switching center of the manner in which voice data intended for the mobile communications device is to be routed. Notably, the inventive arrangements disclosed herein do not require “mobile IP addressing.” This improves scalability by eliminating the potential congestion at a mobile IP server.

One aspect of the present invention can include a method of roaming between mobile and wireless networks. The method can include detecting a wireless network, querying the wireless network for an Internet Protocol address for a mobile device, and receiving the Internet Protocol address. The method further can include sending a message to a mobile switching center of the mobile network using a mobile network control channel. The message instructs the mobile switching center to route voice data intended for the mobile device to the Internet Protocol address via a communicatively linked gateway and the wireless network.

The mobile switching center can be configured to route voice data intended for the mobile device to the Internet Protocol address via the communicatively linked gateway and the wireless network. The method also can include receiving voice data from the gateway via the wireless network.

In another embodiment, the mobile device can be in communication with a different wireless network or a mobile network prior to the detecting step.

Another aspect of the present invention can include a method of roaming between mobile and wireless networks including communicating over a wireless network, detecting that a mobile device is roaming outside a coverage area of the wireless network, and sending a message to a mobile switching center of a mobile network using a mobile network control channel. The message can instruct the mobile switching center to route voice data intended for the mobile device to the mobile device using at least one mobile voice channel.

Accordingly, the mobile switching center can be configured to route voice data intended for the mobile device to the mobile device via the at least one mobile voice channel. The method further can include receiving voice data from the mobile switching center via the mobile network.

The present invention also can be embodied as a system having means for performing the various steps disclosed herein as well as a machine readable storage capable of causing a machine to perform the various steps described herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for roaming between wireless and mobile networks in accordance with the inventive arrangements disclosed herein.

FIG. 2 is a flow chart illustrating a method of roaming between wireless and mobile networks in accordance with the inventive arrangements disclosed herein.

### DETAILED DESCRIPTION OF THE INVENTION

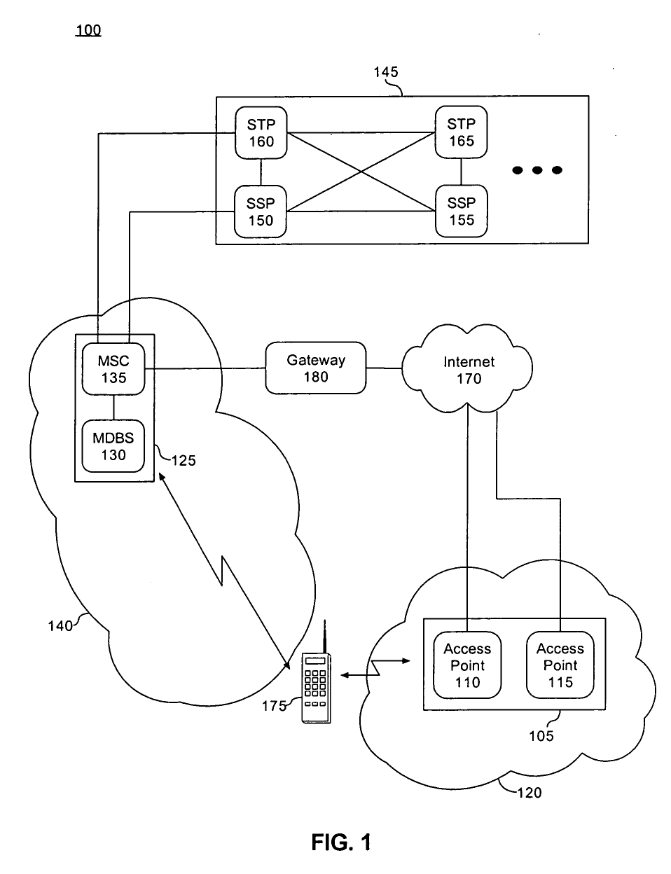

FIG. 1 is a schematic diagram illustrating a system 100 for roaming between one or more mobile communications networks (mobile networks) and wireless communications networks (wireless networks) in accordance with the inventive arrangements disclosed herein. As shown, the system 100 can include one or more wireless networks 105, one or more mobile networks 125, a Public Switched Telephone Network (PSTN) 145, and a packet-switched network such as the Internet 170.

The wireless network 105 can be a wireless network that is compliant with any suitable 802.xx communications protocol including, but not limited to, one of the 802.11, 802.16, 802.20, and/or 802.15 wireless communications protocols. For example, the wireless network can be configured according to the 802.11a, b, g, or 802.15.3 wireless communications protocols. As such, the wireless network 105 can include one or more access points 110 and 115.

Access points 110 and 115 each can include a wireless transceiver for communicating with one or more mobile communication devices which are capable of communicating over an 802.xx wireless connection, for example mobile communications device 175. Each access point 110 and 115 further can include a wired connection to the Internet 170. Accordingly, each access point 110 and 115 is configured to serve as an interface between wireless or mobile communications devices communicating over an 802.xx communications protocol and packet-switched networks such as the Internet 170. The wireless network 105 can have a coverage area 120 within which mobile communication device 145 can communicate over a wireless Voice-Over Internet Protocol (VoIP) channel or other wireless communications link.

The mobile network 125 can be any of a variety of different wireless telephony networks including, but not limited to, a conventional cellular telephony network or a Personal Communications Service (PCS) network (hereafter referred to as a “mobile network”). The mobile network 125 can include one or more Mobile Data Base Stations (MDBS) 130 and a Mobile Switching Center (MSC) 135. As shown, the mobile network 125 can have a coverage area 140 within which mobile communications device 175 can wirelessly communicate with the MDBS 130 over a voice channel and/or a mobile network control channel.

The MDBS 130 can send communications to and receive communications from wireless devices such as mobile communications device 175. For example, the MDBS 130 can include a tower (not shown) for wirelessly communicating with the mobile communications device 175. The tower can be communicatively linked with hardware and any necessary software within the MDBS 130 for converting data streams from the towers into valid signals and routing cellular (or mobile) switched data calls to the MSC 135 and/or another mobile destination. The MDBS 130 manages and accesses the radio interface of the mobile communications device 175 from the mobile network side.

The MSC 135 includes hardware and any necessary software for connecting calls by switching the digital voice data packets from one network path to another. The MSC 135 effectively routes calls between the MDBS 130, the PSTN 145, and/or the Internet 170. Additionally, the MSC 135 can provide information such as user registration, authentication, and location updating.

System 100 further can include a gateway 180. The gateway 180 can include hardware and any necessary software to serve as an interface between the mobile network 125 and the Internet 170. It should be appreciated, however, that the gateway 180 also can be configured to serve as an interface to the PSTN 145. While the gateway 180 can serve as an interface to the Internet 170, the gateway 180 also can be used as an interface to other packet-switched networks (not shown) such as Wide Area Networks, Local Area Networks, intranets, or the like.

In any case, the gateway 180 can format convert received data from the mobile network 125 or the Internet 170 for transmission over a different one of the networks. In illustration, the gateway 180 can receive data formatted for use over the mobile network 125 and packet-switched data for use over the Internet 170. With regard to the Internet 170 or other packet-switched networks, the gateway 180 can send and receive Voice-Over Internet Protocol (VoIP) formatted data for conducting calls over such networks. The gateway 180 can convert data from one format to another so that data can be freely exchanged between the mobile network 125 and the Internet 170.

It should be appreciated that while the gateway 180 is depicted as being located separately from the mobile network 125, the gateway 180 need not be so located. Rather, the gateway 180 can be included as part of the Internet 170 or the mobile network 125.

The PSTN 145 can include Service Switching Points (SSP) 150 and 155, Signal Transfer Points (STP) 160 and 165, and one or more switching systems (not shown). The SSP's 150 and 155 are telephone switches interconnected by Switching System No. 7 (SS7) communication links. SSP's 150 and 155 perform call processing on calls that originate, tandem, or terminate at each respective site. The SSP's 150 and 155 can generate SS7 messages to transfer call-related information to other SSP's (not shown) or to query a Service Control Point (not shown) for routing instructions. The STP's 160 and 165 are switches that relay messages between network switches and databases. The STP's 160 and 165 can route SS7 messages to the correct outgoing signaling link based on SS7 message address fields.

The mobile communications device 175 can be configured to communicate over the mobile network 125 as well as the wireless network 105. The mobile communications device 175 can include wireless transceivers for communicating over both mobile networks and wireless networks. Further, the mobile communications device 175 can be configured to measure the power of signals received from each network and vary the transmission strength of signals sent to each respective network. In one embodiment of the present invention, the mobile communications device 175 can be implemented as a mobile phone. Still, those skilled in the art will recognize that any communications device configured as described herein can be used.

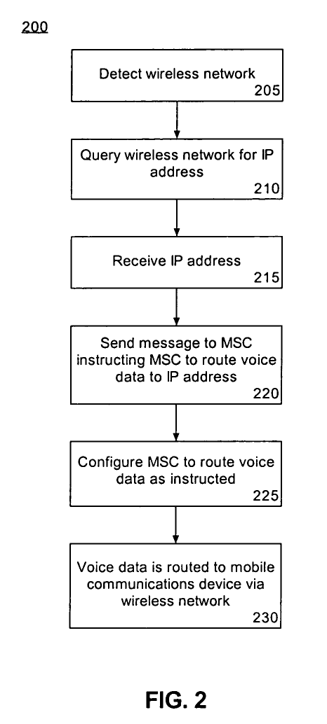

FIG. 2 is a flow chart illustrating a method 200 of roaming between mobile and wireless networks in accordance with the inventive arrangements disclosed herein. The method 200 can begin in a state where a mobile communications device is within the coverage area of a mobile network and roams within the coverage area of a wireless network. Accordingly, the method can begin in step 205 where the mobile communications device detects the wireless network.

In step 210, the wireless device can query the wireless network over a wireless communications link for an Internet Protocol (IP) address. That is, the wireless device can send a wireless message via the wireless access point requesting the IP address. The IP address is assigned using standard Internet protocols such as Dynamic Host Configuration Protocol. In step 215, the wireless device can receive the IP address assigned by the wireless network via the wireless communications link.

In step 220, the mobile communications device sends a message to an MSC of the mobile network. The message is sent wirelessly over a mobile network control channel. The message specifies the IP address assigned by the wireless network and further instructs the MSC to route voice data intended for the mobile communications device to the IP address via a gateway interface between the mobile network and the Internet. In step 225, the MSC is reconfigured to route voice data directed to the mobile communications device as instructed.

Accordingly, in step 230, voice data such as voice communications, whether mobile, telephone, or IP telephony calls intended for the mobile device can be routed to the IP address assigned by the wireless network. The voice data is routed to the gateway and through the Internet, for instance as a VoIP call, to the wireless network. The voice data then can be forwarded via a wireless communications link to the mobile communications device. In this manner, a mobile communications device user can roam between a mobile network and a wireless network.

While the method of FIG. 2 has been described with reference to a mobile communications device roaming from a mobile network to a wireless network, it should be appreciated that similar techniques can be used in the case where the mobile communications device roams from one wireless network to another. In illustration, a mobile communications device may be communicatively linked with a first wireless network. The mobile communications device can begin to leave the coverage area of the first wireless network and begin to enter the coverage area of a second wireless network. The mobile communications device can detect the second wireless network and further detect a stronger signal from the second wireless network than from the first.

Accordingly, the mobile communications device can request an IP address from the second wireless network. Once received, the mobile communications device can send a message over the mobile network control channel to the MSC instructing the MSC to route voice data intended for the mobile communications device to the new IP address—that is the IP address assigned by the second wireless network.

In the event that the mobile communications device roams from a wireless network to a mobile network, the mobile communications device can send a message to the MSC over the mobile network control channel instructing the MSC to begin routing voice data intended for the mobile communications device to the device using one or more mobile voice channels.

The present invention provides a solution that allows mobile communications device users to roam freely between mobile networks and 802.xx wireless networks. The embodiments disclosed herein support both voice and data communications between mobile and wireless networks. As such, mobile users can continue to access both voice and data services whether proximate to a mobile network or a wireless network as described herein.

The present invention can be realized in hardware, software, or a combination of hardware and software. Aspects of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

Aspects of the present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of roaming between mobile and wireless networks comprising:
detecting a wireless network;
querying the wireless network for an Internet Protocol address for a mobile device;
receiving the Internet Protocol address; and
sending a message to a mobile switching center of the mobile network using a mobile network control channel, wherein the message instructs the mobile switching center to route voice data intended for the mobile device to the Internet Protocol address via a communicatively linked gateway and the wireless network.

2. The method of claim 1, further comprising receiving voice data from the gateway via the wireless network.

3. The method of claim 1, further comprising configuring the mobile switching center to route voice data intended for the mobile device to the Internet Protocol address via the communicatively linked gateway and the wireless network.

4. The method of claim 1, wherein prior to said detecting step, the mobile device is in communication with a different wireless network.

5. A method of roaming between mobile and wireless networks comprising:
communicating over a wireless network;
detecting that a mobile device is roaming outside a coverage area of the wireless network; and
sending a message to a mobile switching center of a mobile network using a mobile network control channel, wherein the message instructs the mobile switching center to route voice data intended for the mobile device to the mobile device using at least one mobile voice channel.

6. The method of claim 5, further comprising receiving voice data from the mobile switching center via the mobile network.

7. The method of claim 5, further comprising configuring the mobile switching center to route voice data for the mobile device to the mobile device via the at least one mobile voice channel.

8. A system for roaming between mobile and wireless networks comprising:
means for detecting a wireless network;
means for querying the wireless network for an Internet Protocol address for a mobile device;
means for receiving the Internet Protocol address; and
means for sending a message to a mobile switching center of the mobile network using a mobile network control channel, wherein the message instructs the mobile switching center to route voice data intended for the mobile device to the Internet Protocol address via a communicatively linked gateway and the wireless network.

9. The system of claim 8, further comprising means for receiving voice data from the gateway via the wireless network.

10. The system of claim 8, further comprising means for configuring the mobile switching center to route voice data intended for the mobile device to the Internet Protocol address via the communicatively linked gateway and the wireless network.

11. The system of claim 8, wherein prior to operation of said means for detecting, the mobile device is in communication with a different wireless network.

12. A system for roaming between mobile and wireless networks comprising:
means for communicating over a wireless network;
means for detecting that a device is roaming outside a coverage area of the wireless network; and
means for sending a message to a mobile switching center of a mobile network using a mobile network control channel, wherein the message instructs the mobile switching center to route voice data intended for the mobile device to the mobile device using at least one mobile voice channel.

13. The system of claim 12, further comprising means for receiving voice data from the mobile switching center via the mobile network.

14. The system of claim 12, further comprising means for configuring the mobile switching center to route voice data intended for the mobile device to the mobile device via the at least one mobile voice channel.

15. A machine readable storage, having stored thereon a computer program having a plurality of code sections executable by a machine for causing the machine to perform the steps of:
detecting a wireless network;
querying the wireless network for an Internet Protocol address for a mobile device;
receiving the Internet Protocol address; and
sending a message to a mobile switching center of the mobile network using a mobile network control channel, wherein the message instructs the mobile switching center to route voice data intended for the mobile device to the Internet Protocol address via a communicatively linked gateway and the wireless network.

16. The machine readable storage of claim 15, further comprising receiving voice data from the gateway via the wireless network.

17. The machine readable storage of claim 15, further comprising configuring the mobile switching center to route voice data intended for the mobile device to the Internet Protocol address via the communicatively linked gateway and the wireless network.

18. The machine readable storage of claim 15, wherein prior to said detecting step, the mobile device is in communication with a different wireless network.

19. A machine readable storage, having stored thereon a computer program having a plurality of code sections executable by a machine for causing the machine to perform the steps of:
communicating over a wireless network;
detecting that a mobile device is roaming outside a coverage area of the wireless network; and
sending a message to a mobile switching center of a mobile network using a mobile network control channel, wherein the message instructs the mobile switching center to route voice data intended for the mobile device to the mobile device using at least one mobile voice channel.

20. The machine readable storage of claim 19, further comprising receiving voice data from the mobile switching center via the mobile network.

21. The machine readable storage of claim 19, further comprising configuring the mobile switching center to route voice data intended for the mobile device to the mobile device via the at least one mobile voice channel.
